(19) United States
(12) Patent Application Publication
(10) Pub. No.: US 2005/0276165 A1
(43) Pub. Date: Dec. 15, 2005

(54) N-way timing apparatus

(76) Inventor: Po-Pin Chien, Sinjhuang (TW)

Correspondence Address: RABIN & Berdo, PC, 1101 14TH STREET, NW, SUITE 500, WASHINGTON, DC, 20005, US

(21) Appl. No.: 11/151,288

(22) Filed: Jun. 14, 2005

(30) Foreign Application Priority Data
Jun. 14, 2004 (TW) 93117104

(51) Int. Cl. G04B 45/00

(52) U.S. Cl. 368/107

(57) ABSTRACT

An n-way timing apparatus includes a main body, several event timing keys, several timing modules, a display, and a display module. The event timing keys are disposed on the main body. Each of the event timing modules is coupled to one event timing key, for counting time of a corresponding event. The display is disposed on the main body and coupled to the display module. The display module is for displaying a total timing area and several event timing areas on the display. The total timing area shows a total time period, and each of the event timing areas shows an event occurring period for a corresponding event during the total time period.

This application claims the benefit of Taiwan application Serial No. 93117104, filed Jun. 14, 2004, the subject matter of which is incorporated herein by reference.

### BACKGROUND OF THE INVENTION

1. Field of the Invention

The invention relates in general to a timing apparatus, and more particularly to an n-way timing apparatus.

2. Description of the Related Art

A conventional stopwatch has the following timing functions: counting the total ball-holding time for a specific ball player when applied to a ball game, counting the total speaking time for a specific speaker when applied to a debate, and counting the total time of checking e-mail for a person in the morning when applied to office time management. Conventionally, besides acting as a single timekeeper, the stopwatch may have other applications, such as lap timing and split timing. Referring to FIG. 1A, lap timing is used to separately and successively count time periods t1 to t4 for a single event E1. The event E1 occurs successively, and the time periods t1 to t4 represent different occurring periods of the event E1. Referring to FIG. 1B, split timing is used to separately count time periods t1 to t4 for multiple events E1 to E4. The events E1 to E4 occur concurrently, and the time periods t1 to t4 represent the occurring periods separately for event E1 to E4. However, it requires several stopwatches to separately count the time periods for multiple events, which individually happen during a specific period (i.e. period T) with some overlapping occurring periods. Examples are counting individual ball-holding time for every ball player during a ball game, counting the individual speaking time for every speaker during a debate, and counting the individual time of checking e-mail, meeting, and working for a person in the morning. Using several stopwatches for counting time periods for multiple events not only is inconvenient but also is costly inefficient. In particular, it results in timing inaccuracy and errors to handle several stopwatches for timing the switched events.

### SUMMARY OF THE INVENTION

It is therefore an object of the invention to provide an n-way/multiple-way timing apparatus, which can be applied to various timing circumstances/conditions. The user can use a single device to perform timing for multiple events so as to efficiently manage time and analyze time allocation.

The invention achieves the above-identified object by providing an n-way timing apparatus, including a main body, several event timing keys, several timing modules, a display, and a display module. The event timing keys are disposed on the main body. Each of the event timing modules is coupled to one event timing key, for timing a corresponding event. The display is disposed on the main body and coupled with the display module. The display module is for displaying a total timing area and several event timing areas on the display. The total timing area shows a total time period, and each of the event timing area shows an event occurring period for a corresponding event during the total time period. Besides, each of the event timing areas corresponds to one event timing key. When a user presses an event timing key, the corresponding event timing module will count the event occurring period for the corresponding event during the total time period.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a time chart showing lap timing function of a conventional stopwatch.

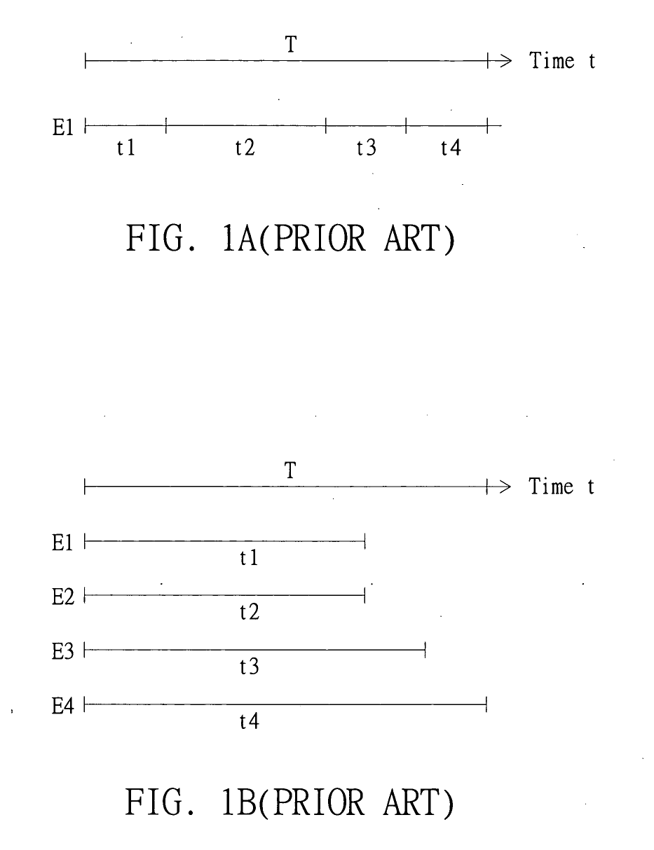

FIG. 1B (Prior Art) is a time chart showing split timing function of a conventional stopwatch.

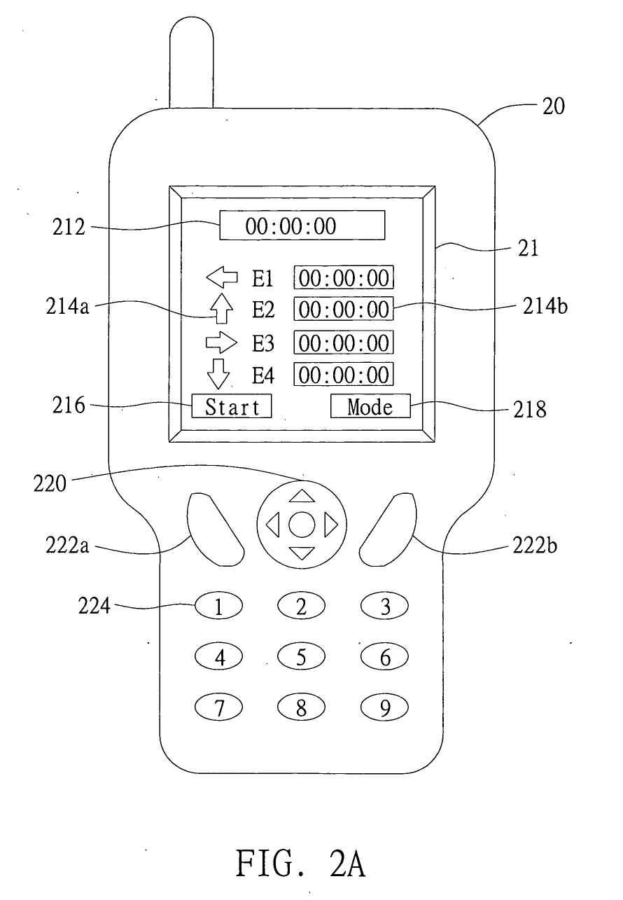

FIG. 2A shows an n-way timing apparatus according to a preferred embodiment of the invention.

FIG. 2B is a block diagram of the n-way timing apparatus in FIG. 2A.

FIGS. 3A-3B show another displaying way for the n-way timing apparatus in FIG. 2A.

FIG. 4A is a timing chart of the n-way timing apparatus under a first timing mode according to the preferred embodiment of the invention.

FIG. 4B is a timing chart of the n-way timing apparatus under a second timing mode according to the preferred embodiment of the invention.

FIGS. 5A-5C illustrate the operation procedure of the n-way timing apparatus under a first timing mode according to the preferred embodiment of the invention.

FIGS. 6A-6D illustrate the operation procedure of the n-way timing apparatus under a second timing mode according to the preferred embodiment of the invention.

FIG. 7 illustrates the display of the n-way timing apparatus when being applied in a patent evaluation meeting according to the preferred embodiment of the invention.

### DETAILED DESCRIPTION OF THE INVENTION

The n-way timing apparatus according to the invention is able to separately count event occurring periods of multiple events, which individually happen during a total time period with some overlapping occurring periods, and to calculate ratios of the event occurring periods to the total time period. Besides, the user can use a single device, i.e. the n-way timing apparatus according to the invention, to perform timing under various timing circumstances/conditions. For example, different events might concurrently or not concurrently happen, each event might successively or not successively occur, and each event might happen once or several times.

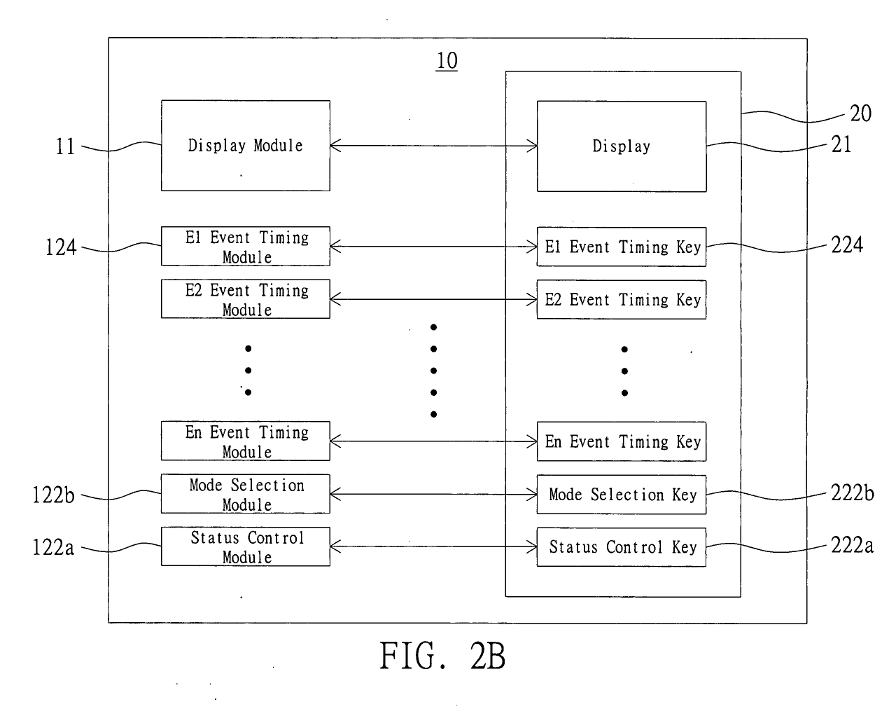

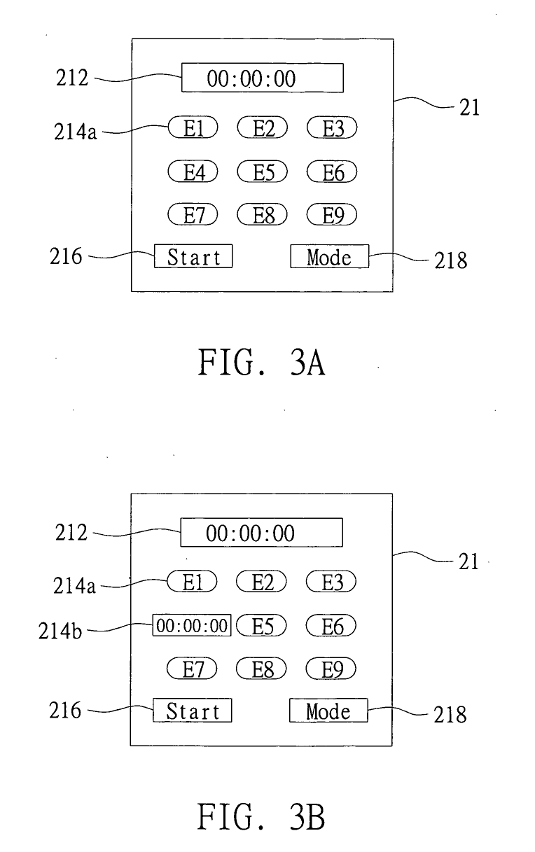

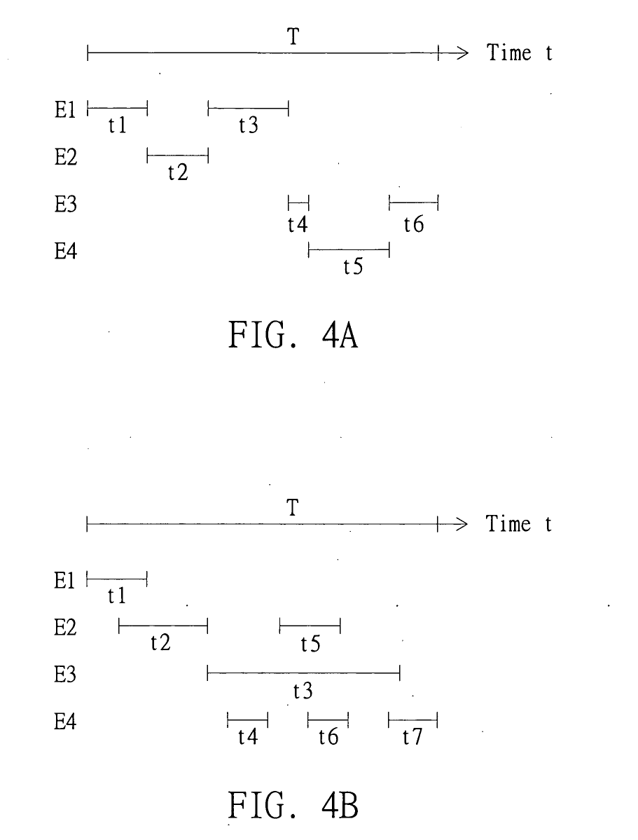

Referring to FIG. 2A, an n-way timing apparatus according to a preferred embodiment of the invention is shown. The n-way timing apparatus includes a main body 20, several event timing keys 220/224, and a display 21. Several event timing keys 220/224 and the display 21 are disposed on the main body 20. In practice, the n-way timing apparatus is an electronic device having several keys 220/224 and a display 21, which may be a mobile phone, a Personal Digital Assistance (PDA), or an electric watch. Therefore, the main body 20 can be a mobile phone main body, a Personal Digital Assistance (PDA) main body, or an electric watch main body. Several event timing keys can be the direction keys 220 or numeric keys 224. The direction keys 220 including up, down, left, and right keys are regarded as four event timing keys, as shown in FIG. 2, to separately perform timing for four events E1 to E4. The numeric keys 224 are regarded as nine event timing keys, as shown in FIGS. 3A and 3B, to separately perform timing for nine events E1 to E9.

Refer to both FIGS. 2A and 2B. The display module 11 is coupled to the display 21, for displaying a total timing area 212 and several event timing areas 214b on the display 21. The total timing area 212 shows a total time period, and each of the event timing area 214b shows an event occurring period for a corresponding event during the total time period. Namely, the corresponding event occurs during the total time period. Each of the event timing area 214b corresponds to one event timing key 220/224. The display module 11 further displays several key hints 214a on the display 21, each of which corresponds to one event timing area 214b. The key hints 214a and the event timing areas 214b are simultaneously and correspondingly displayed on the display 21 as shown in FIG. 2A. Besides, the display module 11 further displays several event occurring percentages on the display 21. Each of the event occurring percentages corresponds to one event timing area 214b for representing a ratio of the event occurring period to the total time period for the corresponding event. The event occurring percentages and the event timing areas are simultaneously and correspondingly displayed on the display. Further, each of the event occurring percentages will be updated every certain time interval, every 1/100 second for example.

The n-way timing apparatus further includes a status control key 222a disposed on the main body 20. The display module 11 further displays a status control area 216 on the display 21. The user presses the status control key 222a to control the total timing area 212 and the event timing areas 214b to start timing, end timing, resume timing, or reset timing. The n-way timing apparatus further includes a mode selection key 222b disposed on the main body 20. The display module 11 further displays a mode selection area 218 on the display 21. The user can select the timing mode by pressing the mode selection key 222b.

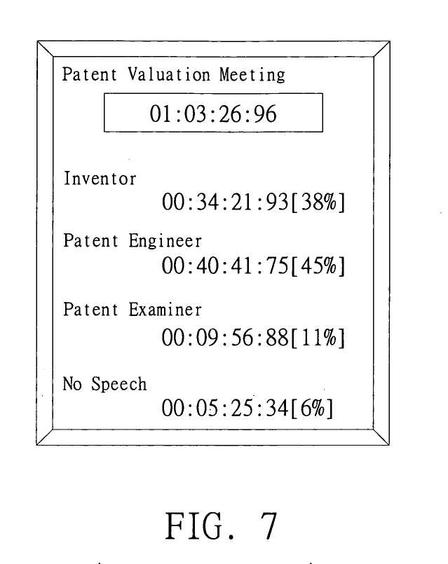

In addition, the user can input/edit descriptions to be shown on the areas of the display 21. When the mode selection key 222b is pressed for a predetermined time (i.e. a long press), an editing function will be activated so as to show an editing frame. Therefore, the user can input/edit a description for representing what the total time period mean. That description will be shown on the total timing area 212 together with and in front of the total time period. Similarly, when one event timing key 220/224 is pressed for a predetermined time (i.e. a long press), the user can input/edit a description for representing the meaning of the corresponding event period. The description will be shown on the corresponding event timing area 214b together with and in front of the corresponding event occurring period. As shown in FIG. 7, the display of the n-way timing apparatus according to the preferred embodiment of the invention is illustrated, when the n-way timing apparatus is applied to a patent evaluation meeting. The user can use the editing function to input/edit a description of “patent evaluation meeting” to be shown on the total timing area together with and in front of the total time period, illustrating that the total time period represents how long the patent evaluation meeting lasts. Also, the description of “inventor” as well as the event occurring period and the event occurring percentage of the first event E1 are simultaneously and correspondingly shown on the first event timing area, and the first event occurring period represents the speaking time of the inventor during the “patent evaluation meeting.” The description of “patent engineer” as well as the event occurring period and the event occurring percentage of the second event E2 are simultaneously and correspondingly shown on the second event timing area, and the second event occurring period represents the speaking time of the patent engineer during the “patent evaluation meeting.” Similarly, the description of “patent examiner” is for the third event E3, representing the speaking time of the patent examiner during the “patent evaluation meeting,” while the description of “no speech” is for the four event E4, representing the time when no one speaks during the meeting. Therefore, the user can apply the invention to perform timing for the patent evaluation meeting so as to efficiently count the speaking time of every participant and the time of no speech. Furthermore, the event occurring percentages (ratios of the event occurring periods to the total time period) are automatically calculated so as to show the speech acts and situations during the patent evaluation meeting.

FIG. 2B is a block diagram of the n-way timing apparatus in FIG. 2A. The n-way timing apparatus 10 according to the preferred embodiment of the invention further includes several event timing modules 124 of events E1 to En, a mode selection module 122b, a status control module 122a, and the display module 11. Referring both to FIGS. 2A and 2B, each of the event timing modules 124 is connected to one event timing key 224, for timing a corresponding event. When a user presses one event timing key 224, the corresponding event timing module 224 counts the corresponding event occurring period during the total time period. The display 21 is coupled with the display module 11. The status control module 122a is coupled to the status control key 222a, for controlling statuses of the total timing area 212 and the event timing areas 214b. The statuses include a start status, a stop status, a resume status, and a reset status. The mode selection module 122b is coupled to the mode selection key 222b, for controlling the timing mode of the n-way timing apparatus. The timing mode can be a first timing mode or a second timing mode.

Referring to FIGS. 3A and 3B, another displaying way of the n-way timing apparatus in FIG. 2A is shown. When timing more than four events, the numeric keys 224 are used as event timing keys for performing timing thereof. In consideration of screen size, the key hints 214a and the event timing areas 214b are alternatively displayed on the display 21, not simultaneously. As shown in FIG. 3A, the display 21 only displays the key hints 214a of events E1 to E9. As shown in FIG. 3B, the display 21 displays the event timing area 214b instead of the key hint 214a for event E4. Besides, the display module 11 further displays several event occurring percentages on the display 21. Each of the event occurring percentages corresponds to one event timing area 214b for representing a ratio of the corresponding event period to the total time period. The events occurring percentages and the event timing areas 214b are simultaneously displayed on the display 21. Further, the event occurring percentages will be updated every certain time interval, every 1/100 second for example.

The n-way timing apparatus according to the invention can be applied to various timing conditions/circumstances. The following further description is directed to a first timing mode, which is applied in the situation, where multiple events do not concurrently happen and have no overlapping occurring periods, and is further directed to a second timing mode, which is applied in the situation, where multiple events can concurrently happen and have some overlapping occurring periods.

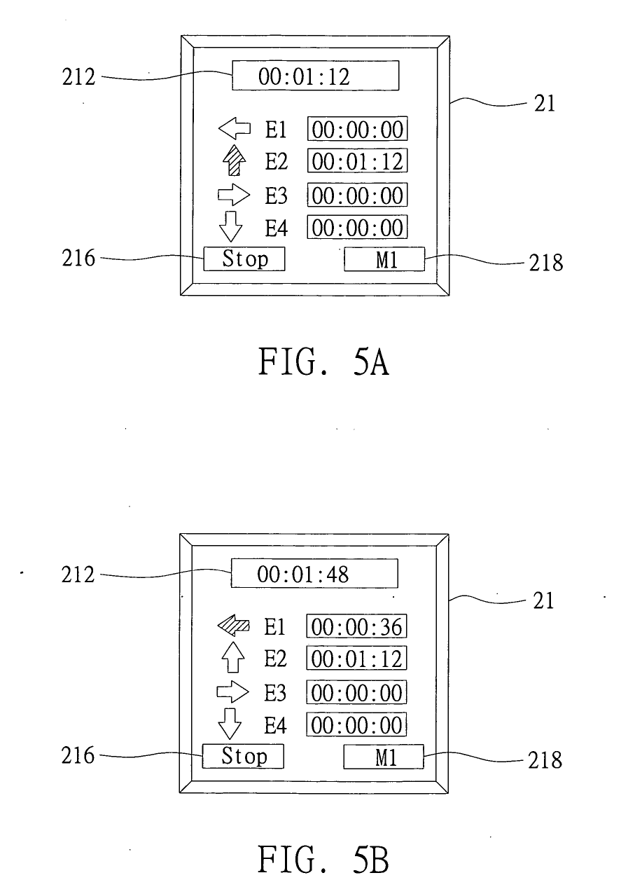

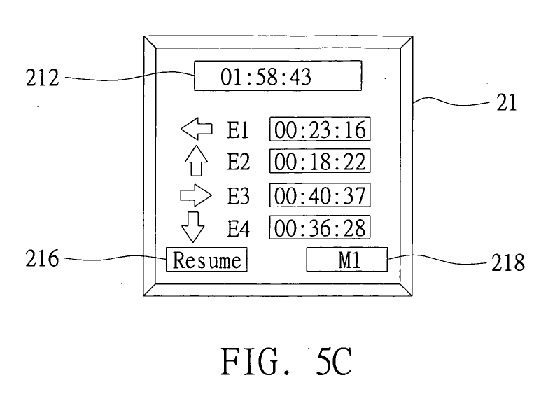

Referring to FIG. 4A, a timing chart of the n-way timing apparatus under a first timing mode according to the preferred embodiment of the invention is shown. Under the first timing mode, the n-way timing apparatus is used for timing several events, any two of those are entirely separate. Namely, the events separately occur without any concurrence (i.e. without any overlapping occurring periods). As shown in FIG. 4A, time periods t1 to t6 represent the occurring periods for four events during the total time period T. Each of the four events separately occur, and may occur once or several times. The total time period T is the sum of the six time periods (event occurring periods) t1 to t6, satisfying T=t1+t2+t3+t4+t5+t6. The first event E1 happens twice, and has the two occurring periods t1 and t3 during the total time period T. Therefore, the first event period T1 equals to t1+t3. The second event E2 happens once, and has the occurring period t2 during the total time period T. Therefore, the second event period T2 equals to t2. The third event E3 happens twice, and has two occurring period t4 and t6 during the total time period T. Therefore, the third event period T3 equals to t4+t6. The fourth event E4 happens once, and has the occurring period t5 during the total time period T. Therefore, the fourth event period T4 equals to t5. Therefore, under the first timing mode, the n-way timing apparatus according to the invention can be applied for timing several separate events so as to obtain the event occurring periods for the multiple events during a total time period.

Under the first timing mode, which is applied in the situation where multiple events do not concurrently happen, the events that successively happen are further distinguished from the events that do not successively happen. Taking events E1 to E4 in FIG. 4A for example, events E1 to E4 are the events that successively happen. The situation, where events do not successively happen, means that some interval(s), during that/those no event happens, exist in the total time period T. Namely, the later event does not occur immediately after the ending of the former event, and therefore, the later event does not successively follow the former event. As shown in FIG. 4A, if time period t2 is an interval, during which no event happens, the event E2 is regarded as an empty event without any occurring of event. Thus, the timing chart of FIG. 4A shows that the third event E3 does not happen immediately after the ending of the first event E1. Instead, the event E3 occurs after the interval of the empty event E2. Namely, the event E3 follows the interval of E2, rather than successively follow the first event E1.

Under the first timing mode, which is applied in the situation where multiple events do not concurrently happen, the events that happen several times are further distinguished from the events that happen only once. As shown in FIG. 4A, both of the first event E1 and the third event E3 happen twice, and are the events that happen several times. If every event is limited to happen once during the total time period T, the six events respectively have the event occurring periods of time periods t1 to t6.

Moreover, the conventional lap timing also can be implemented under the first timing mode by regarding all the events corresponding to time periods t1 to t6 as being a single event E having event period T=t1+t2+t3+t4+t5+t6.

Referring to FIG. 4B, a timing chart of the n-way timing apparatus under a second timing mode according to the preferred embodiment of the invention is shown. Under the second timing mode, the n-way timing apparatus is used for timing several events to obtain event occurring periods for the corresponding events during a total time period, where any two of the event occurring periods are overlapping entirely or partially. As shown in FIG. 4B, four events happen once or several times during the total time period T and therefore, there are seven event occurring periods t1 to t7. Furthermore, two or more events can concurrently happen. The event occurring period t1 for the first event E1 and the event occurring period t2 for the second event E2 are partially overlapping. The event occurring period t3 for the third event E3 and the event occurring period t4 for the fourth event E4 are partially overlapping. The event occurring period t3 for the third event E3, the event occurring period t5 for the second event E2, and event occurring period t6 for the fourth event E4 are partially overlapping. The event occurring period t3 for the third event E3 and the event occurring period t7 for the fourth event E4 are partially overlapping. Therefore, the total time period T is smaller than the sum of the seven event occurring periods t1 to t6, satisfying T<t1+t2+t3+t4+t5+t6+t7. Besides, the first event E1 happens once during the total time period T, and has the event occurring period t1. Therefore, the first event period T1 equals to t1. The second event E2 happens twice during the total time period T, and has two event occurring periods t2 and t5. Therefore, the second event period T2 equals to t2+t5. The third event E3 happens once during the total time period T, and has the event occurring period t3. Therefore, the third event period T3 equals to t3. The fourth event E4 happens thrice during the total time period T, and has three event occurring periods t4, t6, t7. Therefore, the fourth event period T4 equals to t4+t6+t7. Therefore, under the second timing mode, the n-way timing apparatus according to the invention can be applied for timing several events so as to obtain the event occurring periods for the events, which are partially or entirely overlapping, during a total time period.

Under the second timing mode, which is applied in the situation where multiple events may concurrently happen, the events that happen several times are further distinguished from the events that happen only once. As shown in FIG. 4B, the second event E2 happens twice and the fourth event E4 happen thrice during the total time period T, as being the events that happen several times. If every event is limited to happen once during the total time period T, the event occurring periods t1 to t7 are respectively corresponding to seven events, each of those happens once during the total time period T. Moreover, the conventional split timing also can be implemented under the second timing mode, where each event is limited to happen once during a total time period, by setting all of the events to start at the same time, which is the beginning point of the total time period, and concurrently happen. Therefore, the event occurring period for each of the events is obtained and the periods are overlapping as the split timing.

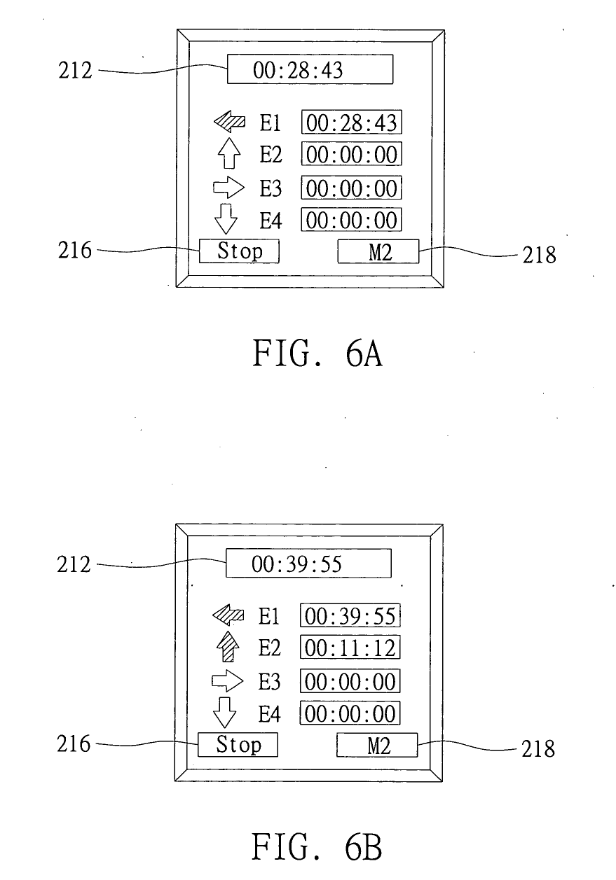

Referring to FIGS. 5A to 5C, the operation procedure of the n-way timing apparatus under a first timing mode according to the preferred embodiment of the invention is shown. Since multiple events do not concurrently happen under the first timing mode, the event timing keys are designed to shifting the timing for events. Each of the event timing key is used for shifting from timing of a preceding event to timing of the corresponding event. That is, when the user presses a specific event timing key corresponding to a first event, if a second event preceding to the first event is being timed, a first event timing module will start timing the first event corresponding to the specific event timing key, and a second event timing module will stop timing the second event so as to obtain the event occurring period of the second event, which is preceding to the first event. As shown in FIG. 2A, in the beginning, all of the total timing area 212 and the event timing areas 214b on the display 21 are set as zero.

Referring to FIG. 5A, a first timing mode M1 is selected by pressing the mode selection key 222b of FIG. 2A and is shown on the mode selection area 218 of the display 21. When the second event E2 happens, the corresponding direction key “up” is pressed to start timing the second event E2. In the meantime, the total timing area 212 and the second event timing area start to show the timing. Referring to FIG. 5B, when the first event E1 happens, the corresponding direction key “left” is pressed to start timing the first event E1 and to stop timing the second event E2. In the meantime, the total timing area 212 continues to show the timing of the total time period, and the first event timing area starts to show the timing of the first event E1 while the second event timing area shows the event occurring period for the second event E2. Subsequently, the above operation procedure continues until the timing for all events to be timed is finished, and the status control key is pressed to stop the timing operation procedure so as to show the stop status on the control area 216. Referring to FIG. 5C, the total timing area 212 and all of the event timing areas stop timing, and the total timing area 212 shows the total time period while the event timing areas show the event occurring periods for the first event E1 to the fourth event E4 during the total time period. Therefore, the ratios of the event occurring periods to the total time period can be clearly understood by looking at the display, and by making use of the ratio information, it is convenient for the user to efficiently manage time and analyze time allocation. Afterward, if the user wants to continue the timing, the user can press the status control key to resume the timing, and the resume status will be shown on the control area 216. Furthermore, the status control key can be long pressed to actuate the reset status, where the timing apparatus will re-start the timing, and the reset status will be shown on the control area 216 while the timing areas on the display 21 will be set as zero.

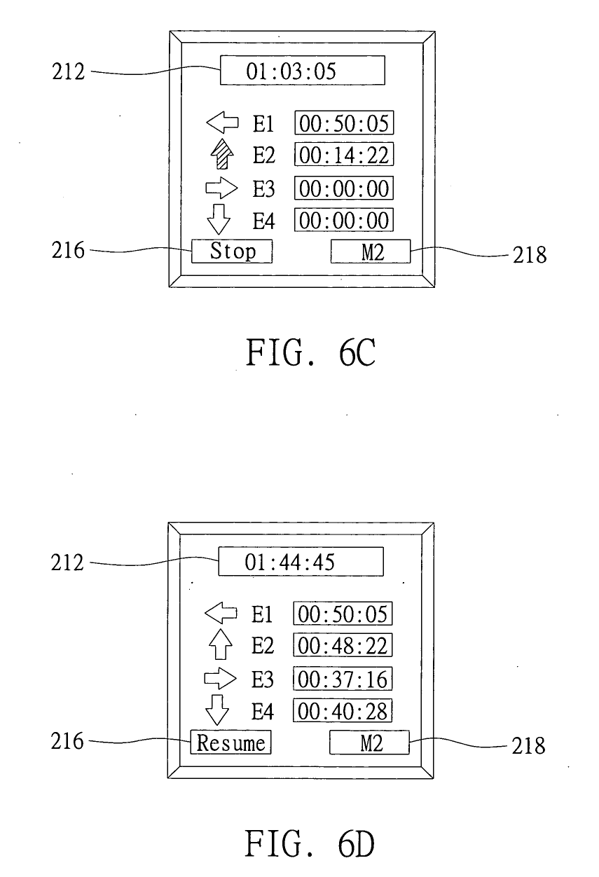

Referring to FIGS. 6A to 6C, the operation procedure of the n-way timing apparatus under a second timing mode according to the preferred embodiment of the invention is shown. Since multiple events can concurrently happen under the second timing mode, the event timing keys are designed to switching on/off the timing. That is, each of the event timing keys is used for switching on the corresponding event timing module to start timing the corresponding event and for switching off the corresponding event timing module to stop timing the corresponding event. Namely, when the user presses an event timing key, the corresponding event timing module starts timing the corresponding event, and when the user presses that event timing key again, the corresponding event timing module stops timing the corresponding event. Therefore, the event occurring period for the corresponding event during the total time period is obtained. As shown in FIG. 2A, in the beginning, the total timing area 212 and all of the event timing areas 214b on the display 21 are set as zero.

Referring to FIG. 6A, a second timing mode M2 is selected by pressing the mode selection key 222b of FIG. 2A and is shown on the mode selection area 218 of the display 21. When the first event E1 happens, the corresponding direction key “left” is pressed to start timing the first event E1. In the meantime, the total timing area 212 and the first event timing area start to show the timing. Referring to FIG. 6B, when the second event E2 happens, the corresponding direction key “up” is pressed to start timing the second event E2. In the meantime, the total timing area 212 continues to show the timing of the total time period, and the first event timing area continues to show the timing of the first event E1 while the second event timing area starts to show the timing of the second event E2. Namely, the apparatus continues to time the first event E1 while starting to time the second event E2. Referring to FIG. 6C, when the first event E1 stops, the corresponding direction key “left” is pressed to stop the timing of the first event E1. In the meantime, the total timing area 212 continues to show the timing of the total time period, and the second event timing area continues to show the timing of the event E2 while the first event timing area show the event occurring period for the first event E1. Subsequently, the above operation procedure continues until the timing for all events to be timed is finished, and the status control key is pressed to stop the timing operation procedure so as to show the stop status on the control area 216. Referring to FIG. 6D, the total timing area 212 and all of the event timing areas stop the timing, and the total timing area 212 shows the total time period while the event timing areas show the event occurring periods for the first event E1 to the fourth event E4 during the total time period. Therefore, the ratios of the event occurring periods to the total time period can be clearly understood by looking at the display, and by making use of the ratio information, it is convenient for the user to efficiently manage time and analyze time allocation. Afterward, if the user wants to continue the timing, the user can press the status control key to resume the timing, and the resume status will be shown on the control area 216. Furthermore, the status control key can be long pressed to actuate the reset status, where the timing apparatus will re-start the timing, and the reset status will be shown on the control area 216 while the timing areas on the display 21 will be set as zero as shown in FIG. 2.

The n-way timing apparatus according to the preferred embodiment of the invention can be applied to various timing conditions/circumstances, and the event occurring periods for multiple events during the total time period can be obtained and the ratios of the event occurring periods to the total time period can be calculated by using a single device, which is costly efficient. Furthermore, by making use of the ratio information, the user can efficiently manage time and analyze the time allocation.

Moreover, the goal of time management in various applications can be achieved. Examples are as follows: counting individual speaking time for every attendant during a meeting, counting individual ball-holding time for every ball player during a ball game, and counting individual spending time for every task such as checking e-mail, making business telephone calls during a specific office time period (i.e. Monday morning).

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An n-way timing apparatus, comprising:
a main body;
a plurality of event timing keys, disposed on the main body;
a plurality of event timing modules, each of which being coupled to one event timing key, for timing a corresponding event;
a display, disposed on the main body; and
a display module, coupled to the display, for displaying a total timing area and a plurality of event timing areas on the display, wherein the total timing area shows a total time period, and each of the event timing areas shows an event occurring period for a corresponding event during the total time period;
wherein each of the event timing areas corresponds to one event timing key, and when a user presses one event timing key, the corresponding event timing module will counts the event occurring period for the corresponding event during the total time period.

2. The apparatus according to claim 1, wherein the display module further displays a plurality of key hints, each of which corresponds to one event timing area.

3. The apparatus according to claim 2, wherein the key hints and the event timing areas are alternatively displayed on the display.

4. The apparatus according to claim 2, wherein the key hints and the event timing areas are simultaneously and correspondingly displayed on the display.

5. The apparatus according to claim 1, wherein the display module further displays a plurality of event occurring percentages, each of which corresponds to one event timing area for representing a ratio of the corresponding event occurring period to the total time period.

6. The apparatus according to claim 5, wherein the event occurring percentages and the event timing areas are alternatively displayed on the display.

7. The apparatus according to claim 2, wherein the events occurring percentages and the event timing areas are simultaneously and correspondingly displayed on the display.

8. The apparatus according to claim 1, wherein each of the event timing key is used for switching on the corresponding event timing module to start timing a corresponding event and for switching off the corresponding event timing module to end timing the corresponding event, wherein when the user presses a specific event timing key, the corresponding event timing module starts timing, and when the user presses the specific event timing key again, the corresponding event timing module ends timing so as to obtain the event occurring period for the corresponding event during the total time period.

9. The apparatus according to claim 8, wherein any two of the event occurring periods corresponding to the event timing modules are overlapping entirely or partially.

10. The apparatus according to claim 1, wherein each of the event timing keys is used for shifting from timing of a preceding event to timing of the corresponding event, wherein when the user presses a specific event timing key corresponding to a first event, if a second event preceding to the first event is being timed, a first event timing module will start timing the first event corresponding to the specific event timing key, and a second event timing module will stop timing the second event so as to obtain the event occurring period of the second (preceding) event.

11. The apparatus according to claim 10, wherein any two of the event occurring periods are not overlapped.

12. The apparatus according to claim 1, wherein when one event timing key is pressed for a predetermined period, a description for the corresponding event is capable of being input/edited, and then the description is displayed together with the corresponding event occurring period on the corresponding event timing area.

13. The apparatus according to claim 1 further comprising:
a status control key, disposed on the main body; and
a status control module, coupled to the status control key, for controlling statuses of the total timing area and the plurality of event timing areas;
wherein the status is one of a start status, a stop status, a resume status, and a reset status.

14. The apparatus according to claim 13, wherein the display module further displays a status control area on the display, the user presses the status control key to control the total timing area and the event timing areas for starting timing, ending timing, resuming timing or resetting timing.

15. The apparatus according to claim 1 further comprising:
a mode selection key, disposed on the main body; and
a mode selection module, coupled to the mode selection key, for controlling the timing mode of the apparatus, the timing mode is one of a first timing mode and a second timing mode.

16. The apparatus according to claim 15, wherein the display module further displays a mode selection area on the display, and the user selects the timing mode of the apparatus by pressing the mode selection key.

17. The apparatus according to claim 15, wherein when the mode selection key is pressed for a predetermined time period, a description for the total time period is capable of being input/edited, and then the description is displayed together with and the total time period on the total timing area.

18. The apparatus according to claim 1, wherein the event timing keys are a plurality of direction keys,

19. The apparatus according to claim 1, wherein the event timing keys are a plurality of numeric keys,

20. The apparatus according to claim 1, wherein the main body is selected from the group consisting of:
a mobile phone main body, a Personal Digital Assistance PDA) main body, and an electric watch main body.

21. An n-way timing method, comprising:
pressing an event timing key so that an event timing module corresponding to the event timing key counts an event occurring period for a corresponding event during a total time period; and
displaying a total timing area and at least one event timing area on a display, wherein the total timing area shows a total time period, and the event timing area shows the event occurring period during the total time period, and wherein the event timing area corresponds to an event timing key.

22. The method according to claim 21, wherein the displaying step comprises:
displaying at least one key hint, which corresponds to the event timing area.

23. The method according to claim 22, wherein the displaying step comprises:
alternatively displaying the key hint and the event timing area on the display.

24. The method according to claim 22, wherein the displaying step comprises:
simultaneously and correspondingly displaying the key hint and the event timing area on the display.

25. The method according to claim 22, wherein the displaying step comprises:
displaying at least one event occurring percentage, which corresponds to the event timing area for representing a ratio of the corresponding event occurring period to the total time period.

26. The method according to claim 25, wherein the displaying step comprises:
alternatively displaying the event occurring percentage and the event timing area on the display.

27. The method according to claim 25, wherein the displaying step comprises:
simultaneously and correspondingly displaying the event occurring percentage and the event timing area on the display.

28. The method according to claim 24, wherein the event timing key is used for switching on the corresponding event timing module to start timing a corresponding event and for switching off the corresponding event timing module to end timing the corresponding event, wherein the method further comprising:
pressing the event timing key so that the corresponding event timing module starts timing;
pressing the event timing key again so that the corresponding event timing module ends timing; and
obtaining the event occurring period for the corresponding event during the total time period.

29. The method according to claim 28, wherein any two of the event occurring periods corresponding to the event timing modules are overlapping entirely or partially.

30. The method according to claim 24, wherein the event timing key is used for shifting from timing of a preceding event to timing of the corresponding event, wherein the method further comprises:
pressing a specific event timing key corresponding to a first event;
if a second event preceding to the first event is being timed, a first event timing module will start timing the first event corresponding to the specific event timing key, and a second event timing module will stop timing the second event; and
obtaining the event occurring period of the second (preceding) event.

31. The method according to claim 28, wherein any two of the event occurring periods are not overlapped.

32. The method according to claim 21 further comprising:
pressing one event timing key for a predetermined period, and then a description for the corresponding event being capable of being input/edited; and
displaying the description together with the corresponding event occurring period on the corresponding event timing area.

33. The method according to claim 21 further comprising:
displaying a status control area on the display, wherein the status control area shows statuses of the total timing area and the event timing area, the status is one of a start status, a stop status, a resume status, and a reset status; and
pressing a status control key to control the total timing area and the event timing areas for starting timing, ending timing, resuming timing or resetting timing.

34. The method according to claim 21 further comprising:
displaying a mode selection area on the display, wherein a timing mode is shown on the mode selection area, and the timing mode is one of a first timing mode and a second timing mode; and
pressing the mode selection key to select the timing mode from the first and second timing modes.

35. The method according to claim 34 further comprising:
pressing the mode selection key for a predetermined period, and a description for the total timing period being capable of being input/edited;
displaying the description together with the total time period on the total timing area.

36. An n-way timing apparatus, comprising:
a main body;
a plurality of event timing keys, disposed on the main body;
a plurality of event timing modules, each of which being coupled to one event timing key, for timing a corresponding event;
a display, disposed on the main body; and
a display module, coupled to the display, for displaying a plurality of event timing areas on the display, wherein each of the event timing area shows an event occurring period for the corresponding event;
wherein each of the event timing areas corresponds to one event timing key, and wherein when a user presses one event timing key, the corresponding event timing module will count the event occurring period for the corresponding event.

37. The apparatus according to claim 36, wherein the display module further displays a total timing area, which shows a total time period,
wherein when the user presses one event timing key, the corresponding event timing module will count the event occurring period for the corresponding event during the total time period.

38. An n-way timing method, comprising:
pressing an event timing key so that an event timing module corresponding to the event timing key counts an event occurring period for a corresponding event; and
displaying at least one event timing area on a display, wherein the event timing area shows the corresponding event occurring period, and wherein the event timing area corresponds to an event timing key.

39. The method according to claim 38, further comprising:

40. displaying a total timing area on the display, wherein the total timing area shows a total time period, and the event timing area shows the event occurring period for the corresponding event during the total time period;
wherein when the event timing key is pressed, the corresponding event timing module counts the event occurring period for the corresponding event during the total time period.
